(19) United States
(12) Patent Application Publication
(10) Pub. No.: US 2026/0220516 A1
(43) Pub. Date: Jul. 30, 2026

(54) SYSTEM AND METHODS FOR DISTRIBUTED QUANTUM ALGORITHM COMPRESSION

(71) Applicant: Haiqu, Inc., San Francisco, CA (US)

(72) Inventors: Mykola Maksymenko, San Francisco, CA (US); Richard Givhan, San Francisco, CA (US)

(21) Appl. No.: 19/144,861

(22) PCT Filed: Dec. 27, 2023
(86) PCT No.: PCT/US2023/086011

§ 371 Date: Jun. 30, 2025

Related U.S. Application Data
(60) Provisional application No. 63/436,505, filed on Dec. 31, 2022.

(51) Int. Cl. G06N 10/60

(52) U.S. Cl. CPC G06N 10/60

(57) ABSTRACT

A method for reducing the depth of a quantum computing algorithm, including: generating an array of classical random data values from a selected probability distribution, the array of classical random data values comprising a plurality of vectors; using one or more of the plurality of vectors as parameters to produce an initial state; generating an original quantum circuit starting from the initial state; executing the original quantum circuit to obtain a first set of measurement outputs; generating a compressed parameterized quantum circuit (PQC) starting from the initial state and using the first set of measurement outputs; executing the compressed PQC to obtain a second set of measurement outputs; performing a similarity-based objective function calculation on data obtained from the first and second sets of measurement outputs; and adjusting one or more of the parameters of the compressed PQC based on a result of the similarity-based objective function calculation.

### FIELD OF THE INVENTION

The disclosure relates to quantum computing, and particularly to quantum circuit optimization with a focus on optimizing the operation depth of quantum algorithms.

### BACKGROUND

Quantum circuits comprise multiple quantum logical gates for performing operations that transform the state of a quantum register. The limited efficiency of quantum computing hardware leads to an accumulation of noise within a quantum circuit as the number of computational steps (i.e., the number of quantum logical gates) that are to be performed by that circuit increases. Hence, it is desirable to reduce the number of quantum logical gates in quantum computing algorithms to improve hardware performance and increase computational accuracy.

### SUMMARY OF THE INVENTION

There is provided a method for reducing the depth of a quantum computing algorithm, the method comprising: generating an array of classical random data values from a selected probability distribution, the array of classical random data values comprising a plurality of vectors; using one or more of the plurality of vectors as parameters to produce an initial state; generating an original quantum circuit starting from the initial state; executing the original quantum circuit to obtain a first set of measurement outputs; generating a compressed parameterized quantum circuit (PQC) starting from the initial state and using the first set of measurement outputs; executing the compressed PQC to obtain a second set of measurement outputs; performing a similarity-based objective function calculation on data obtained from the first and second sets of measurement outputs; and adjusting one or more of the parameters of the compressed PQC based on a result of the similarity-based objective function calculation.

The method may further comprise using a discriminator machine learning model to discriminate between outputs generated by running the original quantum circuit and the compressed PQC.

The method may further comprise increasing the depth of the original quantum circuit on a step-by-step basis.

Obtaining data from the first and second sets of measurement outputs may comprise performing quantum state measurements on the original quantum circuit and the compressed PQC by reading out the state of a full qubit array for a sequence of k qubits.

Obtaining data from the first and second sets of measurement outputs may further comprise performing one or more of k-local projective measurements and k-local entanglement measurements.

Obtaining data from the first and second sets of measurement outputs may comprise using a quantum machine learning model.

The quantum machine learning model may be comprised of a plurality of quantum neural networks or quantum support vector machines.

Adjusting one or more of the parameters of the compressed PQC may comprise using a local predictor model based on a local quantum logical operation of a given step of the original quantum circuit.

The local predictor model may be either an artificial neural network or a graph neural network.

The probability distribution may be selected from a group comprising: uniform distribution, normal distribution, gaussian distribution, input probability distribution and Poisson distribution.

The original quantum circuit may be generated using one or more input PQCs.

The parameters for the one or more input PQCs may comprise one or more of amplitude, basis, angle and displacement.

The initial state may be selected by the input PQC from one of a no entanglement state, a low entanglement state and a high entanglement state.

The one or more parameters to be adjusted may be selected from a group comprising amplitude, rotation angle and displacement.

Executing the original quantum circuit and the compressed PQC may comprise for each circuit: extending the circuit from the initial state; and executing the circuit on a quantum processing unit.

The similarity-based objective function calculation may be selected from a group comprising: a mean square error function, a Kullback-Leibler divergence function and a cross entropy loss function.

There is also provided a system for reducing the depth of a quantum computing algorithm, the system being configured to: generate an array of classical random data values from a selected probability distribution, the array of classical random data values comprising a plurality of vectors; use one or more of the plurality of vectors to produce an initial state; generate an original quantum circuit starting from the initial state; execute the original quantum circuit to obtain a first set of measurement outputs; generate a compressed parameterized quantum circuit (PQC) starting from the initial state and using the first set of measurement outputs; execute the compressed PQC to obtain a second set of measurement outputs; perform a similarity-based objective function calculation on data obtained from the first and second sets of measurement outputs; and adjust one or more of the parameters of the compressed PQC based on a result of the similarity-based objective function calculation.

The system may comprise a HPC cluster comprised of the following modules, which are executed sequentially: a quantum circuit pre-processing module configured to perform pre-processing operations on received parameterized quantum circuit data; a quantum circuit decomposition module configured to decompose the quantum circuit into a plurality of quantum circuit slices; a quantum circuit compression module configured to perform compression of the plurality of quantum circuit slices; and a results reconstruction module comprising rules for reconstructing resulting probability distribution produced by execution of the parameterized quantum circuit.

The array of classical random data values may be generated by the HPC cluster.

The HPC cluster may further comprise a local quantum circuit execution module.

The quantum circuit decomposition module may be configured to decompose the parameterized quantum circuit into a plurality of quantum circuit slices.

The decomposition of the parameterized quantum circuit may be performed using a circuit cutting approach or circuit knitting approach.

The HPC quantum simulator may be run either locally, on a cloud server, or via an application programming interface (API) by a third party.

The HPC quantum simulator may use an operating platform that is selected from one of Linux (RTM) and Windows (RTM).

### BRIEF DESCRIPTION OF THE DRAWINGS

FIG. 1 illustrates a system for producing an optimised approximate quantum circuit according to some aspects of the present disclosure;

FIG. 2 illustrates a first quantum circuit compression method based on improving the similarity of projected measurement results according to some aspects of the present disclosure;

FIG. 3 illustrates a second quantum circuit compression method based on the optimization of a quantum discriminator loss function according to some aspects of the present disclosure;

FIG. 4 illustrates a third quantum circuit compression method based on the local update of a parameterized quantum circuit according to some aspects of the present disclosure;

FIG. 5 illustrates a tensor-network inspired circuit rearrangement process to reduce the number of necessary cuts according to some aspects of the present disclosure.

### DETAILED DISCLOSURE

A quantum computer comprises one or more quantum processors, or quantum processing units (QPUs), which perform quantum computing algorithms. The execution of quantum computing algorithms that are performed by the quantum computer is limited by the available quantum volume of its QPU. The reliability of final measurements obtained from the quantum computer decreases with the number of algorithmic steps that are executed on its QPU, which is related to qubit coherence time, gate errors and imperfections. This is because each logical operation (or quantum logical gate) of the QPU intrinsically introduces a gate-based error. When all of the gate-based errors introduced within the quantum computer are added up they can spoil the computational operation of that computer. Hence, it is desirable to reduce the number of logical operations that are performed by a QPU to a preferred maximal number that is proportional to the quantum volume of the QPU.

This disclosure provides a system for transforming large-scale quantum circuits into a compressed and distributed form. The system reduces the depth of quantum computing algorithms by approximating those algorithms with variational quantum circuits or a plurality/collection of quantum circuits. A number of outlined system architectures based on classical and quantum machine learning methodologies are described herein. These architectures enable the representation of an arbitrary quantum computing algorithm in an approximate form. The architectures produce final states similar to those obtained using original quantum algorithms and incur a significantly lower number of computational steps.

To reduce the need for a large number of qubits, the system described herein may decompose a quantum circuit into slices, with each slice requiring only a fraction of the total number of qubits of that circuit. Each quantum circuit slice may be represented as a parameterized quantum circuit (PQC) that fits the required quantum volume via one of the methods disclosed below. The PQCs may be executed on a QPU, and results may be used to reconstruct the measurements of a large-scale quantum circuit.

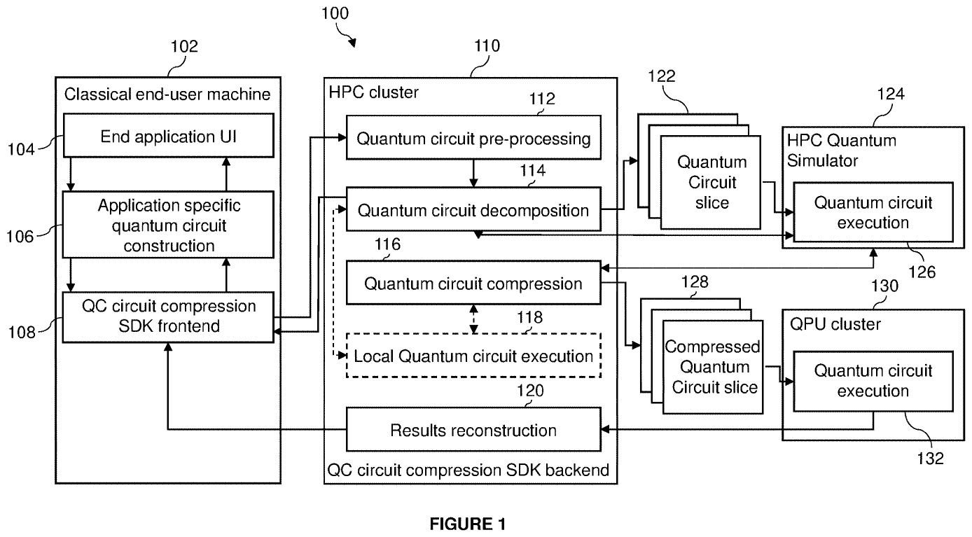

FIG. 1 illustrates a system 100 for producing optimised approximate quantum circuit. The system 100 may be implemented on a computer system. FIG. 1 illustrates the system 100 comprising a plurality of functional blocks. Each block may be executed in hardware or in software (e.g., using processing logic). The illustration of the features of system 100 using functional blocks is schematic only and is not intended to define a strict division between different logic elements of such features. The term “connected”, when used below, may refer to either the physical or logical connection of features.

The system 100 comprises a classical end-user machine 102 and a classical high-performance computing (HPC) cluster 110. The system 100 further comprises an HPC quantum simulator 124. The HPC quantum simulator 124 further comprises a first quantum circuit execution module 126. The system 100 also comprises a QPU cluster 130, the QPU cluster further comprising a second quantum circuit execution module 132.

The system 100 may operate on multiple classical and/or multiple quantum environments.

The first environment of the system 100 may be run on a classical end-user machine 102. The classical end-user machine 102 may otherwise be referred to as a user quantum development machine. The classical end-user machine may be a laptop, a workstation or a cloud machine. The classical end-user machine may run a predetermined operating system. In a first example, the predetermined operating system is Microsoft Windows (RTM). In a second example, the predetermined operating system is Linux (RTM). The predetermined operating system may be any other suitable operating system. The first environment may be run in a predetermined programming language. The predetermined programming language may be Python (RTM). Thus, the first environment may be described as a Python environment. The predetermined programming language may be any other suitable programming language. The classical end-user machine 102 may process a developed quantum circuit. The classical end-user machine 102 may operate via a cloud backend.

The classical end-user machine 102 may have a software development kit that enables a user to execute a quantum algorithm using the system 100. That is, the SDK may be a set of routines and/or an interface which sends user requested information regarding a quantum circuit to a backend environment (e.g., HPC cluster 110). The classical end-user machine 102 comprises an end application user interface (UI) module 104, an application specific quantum circuit construction module 106 and a quantum circuit (QC) compression SDK frontend module 108.

The end application UI module 104 of the classical end-user machine provides a user interface with which a user may interact. The end application UI module 104 may also output the results from the system 100 to a user. The end application UI module 104 is connected to the application specific quantum circuit construction module 106 of the classical end-user machine 102. Thus, the end application UI module 104 may exchange information with the application specific quantum circuit construction module 106. Information may be exchanged in both directions between the end application UI module 104 and the application specific quantum circuit construction module 106.

The application specific quantum circuit construction module 106 may be configured to construct a quantum circuit based on information received from the end application UI module 104. The information received by the application specific quantum circuit construction module 106 from the end application UI module 104 relates to the structure of the input quantum circuit that is to be generated. The application specific quantum circuit construction module 106 may be configured to construct, or develop, a quantum circuit. The quantum circuit may be developed based on one or more data values (or vectors) in the array of classical data values. The quantum circuit that is constructed by the application specific quantum circuit construction module 106 may otherwise be referred to as a first version of a quantum circuit, or the “original” quantum circuit.

In addition to being connected to the end application UI module 104, the application specific quantum circuit construction module 106 may also be connected to the QC circuit compression SDK frontend module 108 of the classical end-user machine 102. Thus, the application specific quantum circuit construction module 106 may exchange information with the QC circuit compression SDK frontend module 108. Information may be exchanged in both directions between the application specific quantum circuit construction module 106 and the QC circuit compression SDK frontend module 108.

The QC circuit compression SDK frontend module 108 may otherwise be referred to as a local SDK. The QC circuit compression SDK frontend module 108 may receive information, or data, indicative of the constructed quantum circuit from the application specific quantum circuit construction module 106. The QC circuit compression SDK frontend module 108 may provide an interface to compress the quantum circuit.

In addition to being connected to the application specific quantum circuit construction module 106, the QC circuit compression SDK frontend module 108 is also connected to the HPC cluster 110 of system 100. More specifically, the QC circuit compression SDK frontend module 108 is connected to a quantum circuit pre-processing module 112 and a results reconstruction module 120 of the HPC cluster 110. The QC circuit compression SDK frontend module 108 may send information to the quantum circuit pre-processing module 112 and may receive information from the results reconstruction module 120. The QC circuit compression SDK frontend module 108 may also, optionally, directly receive information from the quantum circuit decomposition module 114. This information may be received prior to any run of the quantum circuit on a simulator or quantum processing unit.

The second environment of the system 100 may be run on the HPC cluster 110. The HPC cluster 110 may otherwise be referred to as a HPC server, or a HPC backend. The HPC cluster may be run on an in-house server, a local cluster, or on entirely cloud based resources. The HPC cluster 110 may process a quantum circuit from classical end-user machine 102 and apply decomposition and compression methods to that circuit. That is, the HPC cluster 110 may combine the information received from the classical end-user machine 102 together with examples of how the machine (i.e., the input circuit) operates on random input data, to produce an “approximation” of a quantum circuit. The HPC cluster 110 is formed of a plurality of processing modules which may be executed sequentially. The HPC cluster 110 may comprise, in sequential order: a quantum circuit pre-processing module 112, a quantum circuit decomposition module 114, a quantum circuit compression module 116 and a results reconstruction module 120. The HPC cluster also optionally comprises a local quantum circuit execution module 118.

The HPC cluster 110 is connected to the classical end-user machine 102. More specifically, the quantum circuit pre-processing module 112 of the HPC cluster 110 is connected to the QC circuit compression SDK frontend module 108 of the classical end-user machine 102. The function of the HPC cluster 110 is to process the quantum circuit that is developed by the classical end-user (or local) machine 102. The function of the HPC cluster 110 is also to process the results of the quantum circuits executed by modules 124 and 130.

The quantum circuit pre-processing module 112 is configured to perform pre-processing operations of the received quantum circuit that is developed or prepared by the user in the first environment (i.e., using the classical end user machine 102). The quantum circuit data may be received from the QC circuit compression SDK frontend module 108 of the classical end-user machine 102. The pre-processing operations performed by the quantum circuit pre-processing module 112 may prepare the quantum circuit for subsequent processing operations of the HPC cluster 110 environment. The pre-processing operations may also prepare the quantum circuit for execution operations on execution modules 124 and 130. The pre-processing module 112 may be configured to perform one or more of the following pre-processing operations: simplifying the circuit using algebraic circuit identities, rewriting the circuit to account for the QPU native gate set and topology, applying standard quantum compilation passes, rewriting the circuit to reduce the number fragments produced by the decomposition module 114, and generating a plurality of modified circuits for the purpose of error mitigation. The quantum circuit pre-processing module 112 may be connected to the quantum circuit decomposition module 114 of the HPC cluster 110. Thus, quantum circuit pre-processing module 112 may send information to the quantum circuit decomposition module 114.

The quantum circuit decomposition module 114 is configured to receive data from the quantum circuit pre-processing module 112. The quantum circuit decomposition module 114 is configured to apply a decomposition method to the quantum circuit data obtained from the quantum circuit pre-processing module 112. That is, the quantum circuit decomposition module 114 is configured to decompose the received quantum circuit into a plurality of separable fragments, with each fragment requiring a smaller number of qubits than the quantum circuit as a whole. The separable fragments of the quantum circuit may otherwise be referred to as quantum circuit slices 122.

The quantum circuit decomposition module 114 may operate using either via manual or automatic prescriptions. In a first example, the quantum circuit decomposition module 114 operates using a circuit cutting approach, which comprises cutting a quantum circuit at predetermined locations such that the resulting smaller quantum circuits may be executed by the quantum processor. The circuit cutting is performed such that each subcircuit (e.g., a wire-cut portion of the quantum circuit), is executed separately on the quantum processor with measurements performed on the executed subcircuit individually. In a second example, the quantum circuit decomposition module 114 operates using a circuit knitting approach, which comprises combining the results of the individually executed gate-cut subcircuits a quantum circuit to reconstruct the outcome of executing the original quantum circuit. The quantum circuit decomposition module 114 may alternatively use any other similar procedure or combination thereof. Examples of similar procedures include approximate circuit decomposition methods. The decomposition procedure that is performed by the quantum circuit decomposition module 114 defines the further rules for the reconstruction of results for the quantum circuit that is performed by results reconstruction module 120.

The HPC cluster 110 further comprises a quantum circuit compression module 116. The quantum circuit compression module 116 is configured to perform compression on the quantum circuit slices 122 to create a plurality of separable fragments of compressed quantum circuit slices. The quantum circuit compression module 116 may therefore generate a compressed parameterized quantum circuit (PQC) from the quantum circuit slices 112, as described in further detail below. Prior to passing through the quantum circuit compression module 116, the quantum circuit slices 122 may pass through HPC quantum simulator 124. The HPC quantum simulator 124 may be a classical computing unit, or alternatively may be a quantum processing unit. That is, the decomposed quantum circuit slices 122 may be simulated before compression step 116 (or alternatively the quantum circuit slices 122 may be executed on a QPU cluster 130). The quantum circuit compression module 116 is configured to apply a compression method to decomposed quantum circuit data. The separable fragments of compressed data may otherwise be referred to as compressed quantum circuit slices 128. The quantum circuit compression module 116 may compress separable fragments of the quantum circuit using one of a plurality of methods. The quantum circuit compression module 116 is connected to the HPC quantum simulator 124. Thus, the quantum circuit compression module 116 is configured to receive information from the HPC quantum simulator 124. The quantum circuit compression module 116 is also connected to QPU cluster 130. Thus, the quantum circuit compression module 116 is configured to transmit information to the QPU cluster 130 and receive measurement results to run PQC optimisation. In some examples (not illustrated) the quantum circuit compression module 116 may be capable of bidirectional communication (i.e., both sending and receiving information) with the QPU cluster 130. In this example, the module 116 may receive a version of the quantum circuit that has been sent to the QPU cluster, compress that version of the circuit and then send a “final” (i.e., compressed) version of this circuit back to the QPU cluster for execution.

In an alternative example (not illustrated) the system of FIG. 1 may not comprise an HPC quantum simulator 124. In this example, the QPC cluster 130 may be configured to execute, in addition to compressed quantum circuit slices 128, uncompressed circuit slices 122. That is, the QPC cluster 130 may be configured to execute both the original quantum circuit slices and the compressed PQC circuit slices generated by the system. The exclusion of a HPC quantum simulator simplifies the arrangement of the system 100, minimising hardware area and increasing manufacturing efficiency.

The HPC cluster 110 further comprises a results reconstruction module 120. The results reconstruction module 120 may otherwise be referred to as a full circuit result reconstruction module. As mentioned above, the results reconstruction module may be configured to reconstruct the results of executing quantum circuit slices to produce full scale results of the original quantum circuit. The results reconstruction module 120 may comprise rules for reconstructing a probability distribution that is produced by execution of a quantum circuit. The results reconstruction module 120 is connected to the quantum circuit execution module 132 of the QPU cluster 130. The results reconstruction module may be configured to receive information from the QPU cluster 130. The results reconstruction module 120 is also connected to the QC circuit compression SDK frontend module 108 of the classical end-user machine 102. The results reconstruction module 120 may be configured to transmit information to the classical end-user machine 102. The results reconstruction module 120 may also be linked to the quantum circuit decomposition module 114 of the HPC cluster 110.

The HPC cluster 110 may further, optionally, comprise a local quantum circuit execution module 118. The local quantum circuit execution module 118 may be connected to the quantum circuit compression module 116. The local quantum circuit execution module 118 may exchange (i.e., send and receive) information with the quantum circuit compression module 116. The local quantum circuit execution module 118 may otherwise be referred to as a local quantum circuits simulator. The local quantum circuit execution module 118 may be configured to simulate a quantum circuit locally on the HPC cluster 110.

The third environment of the system 100 may be run on a HPC quantum simulator 124 or in the cloud. The HPC quantum simulator may be configured to execute the original quantum circuit (or the quantum circuit slices generated by quantum circuit decomposition module 114) to obtain a first set of measurement outputs. The HPC quantum simulator 124 may comprise one or more quantum processing unit, or quantum circuit execution module 126. That is, the HPC quantum simulator 124 comprises one or more central processing units (CPUs) or graphical processing units (GPUs) that classically simulate the effect of applying one or more sequence of defined gates to an array of qubits.

The HPC quantum simulator 124 is connected to the quantum circuit decomposition module 114 of the HPC cluster 110. The HPC quantum simulator 124 is configured to receive quantum circuit slices 122 from the quantum circuit decomposition module 114. The HPC quantum simulator 124 is further configured to execute the quantum circuit slices. The quantum circuit slices may be referred to as original quantum circuit slices, or original quantum circuit fragments. The HPC quantum simulator 124 is also configured to execute approximate versions of quantum circuit slices 122. That is, the HPC quantum simulator 124 is configured to execute separable parts of the decomposed input of a quantum circuit, and to execute corresponding parameterized approximate quantum circuits. The HPC quantum simulator 124 comprises a first quantum circuit execution module 126. The first quantum circuit execution module 126 may be configured to execute quantum circuit simulation. The first quantum circuit execution module 126 is connected to the quantum circuit compression module 116 of the HPC cluster 110. Thus, the first quantum circuit execution module 126 is configured to exchange (i.e., send and receive) information with the quantum circuit compression module 116.

The HPC quantum simulator 124 may run either on-premise (i.e., locally) or on a cloud server. The HPC quantum simulator 124 may use an operating platform such as Unix (RTM), Linux (RTM) or Windows (RTM). The operating platform for the Quantum Simulators may alternatively be provided via an application programming interface (API) by a third party.

The fourth environment of the system 100 may be run on a QPU, or on a cluster of QPUs 130. The QPU, or cluster of QPUs, may be gate based QPUs. That is, QPU or QPU cluster is configured to process one or more sequences of defined quantum logical gates that are applied to an array of qubits. The QPU or cluster of QPUs are configured to execute a second version of the quantum circuit to obtain a set of measurement outputs. The second version of the quantum circuit is the compressed parametrised quantum circuit (PQC) generated by quantum circuit compression module 116. The compressed PQC, when run on the QPU cluster 130, is used to obtain measurements and, if necessary, to adjust parameters. The “final” version of a PQC (after the adjustment of necessary parameters) is an approximated version of the original quantum circuit/quantum circuit slices. The compressed PQC may be described as an approximated version of the original quantum circuit because it is comprised of compressed quantum circuit data from the original quantum circuit which sacrifices some accuracy in reproducing the quantum state generated by the original quantum circuit in order to decrease the size of the quantum circuit.

FIG. 1 illustrates the fourth environment being run on a QPU cluster 130. The QPU cluster 130 is connected to the quantum circuit compression module 116 of the HPC cluster 110. The QPU cluster 130 is configured to receive compressed quantum circuit slices 128 from the quantum circuit compression module 116. The QPU cluster 130 is further configured to execute approximate quantum circuits slices 128. The compressed quantum circuit slices may be referred to as compressed quantum circuit fragments. The QPU cluster 130 comprises a second quantum circuit execution module 132. The second quantum circuit execution module 132 may be configured to execute the quantum circuit. The second quantum circuit execution module 132 is connected to the results reconstruction module 120 of the HPC cluster 110. Thus, the second quantum circuit execution module 132 is configured to send information to the results reconstruction module 120. This means that the results reconstruction module 120 is configured to reconstruct full scale results at the HPC cluster 110 based on data received from the second quantum circuit execution module 132.

The system of FIG. 1 Is further configured to perform a similarity-based objective function calculation on a data obtained from first and second sets of measurement outputs, where the first set of measurement outputs is obtained at least partially through execution of the original quantum circuit and the second set of measurement outputs is obtained at least partially through execution of the compressed PQC that approximates the original quantum circuit. The system is also configured to adjust one or more of the parameters of the compressed PQC based on the result of the similarity-based objective function calculation. In one example, these steps may be performed by the HPC cluster 110. In another example, these steps may be performed by the classical end-user machine. The steps are described in further detail below.

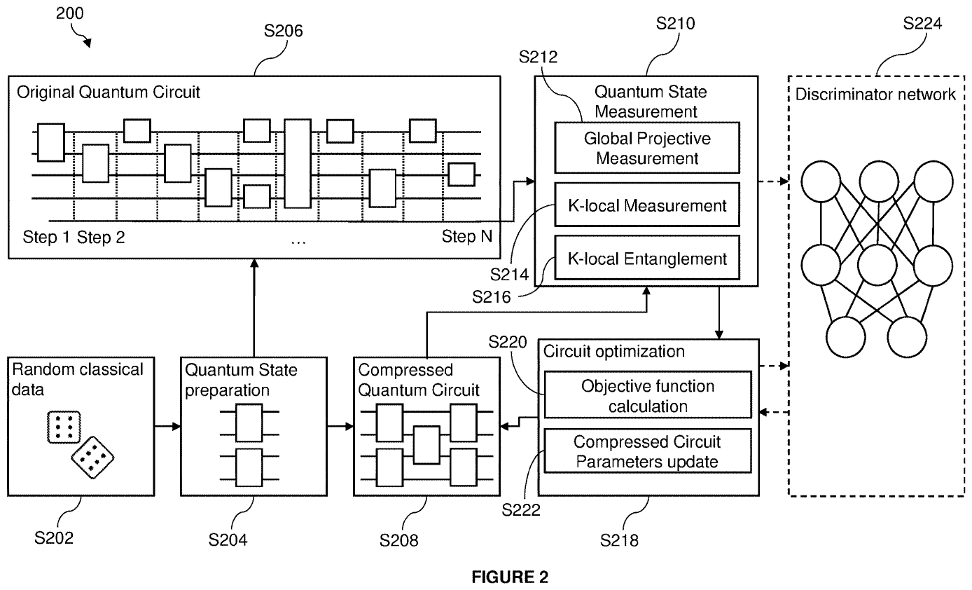

FIG. 2 illustrates a first quantum circuit compression method 200 configured to improve the similarity of projected measurement results. The method 200 may otherwise be described as a method for reducing the depth of a quantum computing algorithm.

Method 200 is initiated at random classical data step S202. Step 202 may be performed at the classical end-user machine 102 of FIG. 1. Alternatively, step 202 may be performed at the HPC cluster 110. Step S202 may otherwise be referred to as random initial quantum state preparation. At step S202 an array of classical random data values is generated. The array of classical random data values is generated from a selected probability distribution (i.e., a given distribution). The probability distribution may be selected from one of uniform distribution, normal distribution, gaussian distribution, input probability distribution or Poisson distribution, or another user-specified probability distribution. The probability distribution may be any other form of distribution that is based on the specifics of a given quantum algorithm. The generated array of classical random data values comprises a plurality of vectors. The vectors may be referred to as random classical vectors. The array of classical random data values may be generated by the HPC cluster 110 of FIG. 1.

Next, at step S204, the one or more vectors of the array of classical random data values as parameters to construct the initial (or input) state for a quantum circuit. More specifically, the initial state for both the original quantum circuit and the compressed PQC is selected at step S204. This means that, at step S204 the random classical vectors may be prepared and transformed into one or more quantum states, which represent the initial state. The initial state is generated using one or more input PQCs. Step S204 may otherwise be referred to as quantum state preparation step. Step 204 may be performed by the HPC cluster 110 of FIG. 1. The random classical vectors may, in some examples, be used to generate a plurality of initial states. The plurality of initial states may be described as randomised initial states.

Examples of parametrisations of the quantum state by the input PQC for which the one or more generated vectors can be used are amplitude, basis, gate angles and displacement. The initial PQC architecture is selected according to one or more predetermined input characteristics. The one or more input characteristics are selected to constrain the input state produced by the input PQC for the original quantum circuit. The initial state for the input PQC may contained to be an untangled state (i.e., a quantum product state), a low entanglement state or a high entanglement state. Alternatively, the initial state may be similar to, or in the vicinity of, a specific quantum state.

Method 200 then proceeds to steps S206, S208, S210 and S218, which are executed consecutively and iteratively. That is, the sequence of steps S206, S208, S210 and S218 may be executed multiple times. In other words, the quantum circuits of steps S206, S208, S210 and S218 are built and executed using a step-by-step strategy, whereby each iteration of step S206 is followed by a respective iteration of steps S208, S210 and S218. That is, building the quantum circuits of steps S206 and S208 comprises increasing the depth of the quantum circuit on a step-by-step basis. This procedure gradually increases the complexity of state produced by the quantum circuits.

At each iteration of step S206, the initial state (or plurality of initial states) is used as an input to the original quantum circuit. That is, at S206 a quantum circuit is built, or generated, starting from (i.e., by extending it from) the input state of S204. The quantum circuit is also executed at step S206. The first version of the quantum circuit may be run (or executed) at each iteration of step S206 to provide the target for the second, approximate, version of the quantum circuit which is updated in step S208. That is, the original quantum circuit may be executed to generate a first set of measurement outputs. The first set of measurement outputs may be used in the generation of a compressed quantum circuit in step S208. The original quantum circuit may be run on a classical quantum simulator. The classical quantum simulator may correspond to the HPC quantum simulator 124 of FIG. 1. Simultaneously, the parameters of the compressed PQC of step S218 are adjusted using the measurements of step S210 (described in further detail below). The parameters may be adjusted based on the results of an objective function calculation.

At each iteration of step S208, the initial state (or plurality of initial states) is used as the input state for the compressed PQC. That is, at S208 a compressed PQC is built starting from the initial state of S204. The compressed PQC, as the name suggests, is a compressed version of the original quantum circuit. The compressed PQC is generated using a first set of measurement outputs that are generated from execution of the original quantum circuit. As with the original quantum circuit, the compressed PQC is built by extending it from the initial state of step S204. In contrast to the original quantum circuit, however, the compressed PQC is not extended after each successive state. Instead, in a first example, only the parameters of the compressed PQC are adjusted by the procedure in step S220, which is performed after each round of step S206. In a second example, the structure of PQC may also be altered to better approximate original quantum circuit. The compressed PQC is an approximation of the original quantum circuit that is executed at step S206. The properties of the compressed PQC may be chosen based on the properties of original quantum circuit, such as resulting distribution, entanglement and graph properties. Once the compressed PQC has been built, it may also be run (or executed) at step S208 on a classical quantum simulator or a QPU. Execution of the compressed PQC results in the generation of a second set of measurement outputs. The classical quantum simulator or QPU may correspond to the QPU cluster 130 of FIG. 1.

Thus, at steps S206 and S208, the initial state of step S204 is used as an input state to build and run both an original quantum circuit and a compressed quantum circuit in parallel. That is original quantum circuit at step S206 and the compressed PQC at step S208 are executed using the same initial state. The initial state is given by the input PQC which is inserted in front of both the original quantum circuit and the compressed PQC, has been selected at step S204. Steps S206 and S208 may be performed in parallel.

At step S210, which follows each iteration of step S206 and step S208, quantum state measurements are performed on both the first (i.e., original) version of the quantum circuit and the second (i.e., compressed parameterized) quantum circuit. That is, at step S210 a quantum state measurement operation is performed on both the original quantum circuit and the compressed PQC. The quantum state measurement operation of step S210 may comprise sub-steps S212, S214 and S216.

At sub-step S212 of step S210 a global projective measurement operation is performed on received data. At sub-step S214 of step S210 a k-local projective measurement is performed on the data. Steps S212 and S214 may include tomographic informationally complete (IC) projective measurements. At sub-step S216 of step S210 a k-local entanglement measurement operation is performed on the data. Sub-steps S212, S214 and S216 are performed on both the original and approximated quantum circuits by reading out the state of a full qubit array or for a sequence of k qubits. This results in a binary sequence of 0 and 1 for a qubit array. By repeating the steps S212, S214 and S216 multiple times, statistics of obtaining one or another binary sequence are accumulated. This enables the computation of multiple derivative properties of underlying quantum states such as entanglement and correlations between qubits.

At step S218 a circuit optimization operation is performed. The circuit optimization operation calculates updated, or improved, parameters for the compressed quantum circuit of step S208. The circuit optimization operation may use results from quantum state measurement step S210 to calculate updated compressed quantum parameters. That is step S218 receives, as inputs, the results of quantum state measurement step S210. Step S218 further comprises sub-steps S220 and S222.

Sub-step S220 of step S218 comprises comparing the results of the measurements from quantum state measurement step S210 using an objective function. More specifically, sub-step S220 comprises using a similarity-based objective function. The similarity-based objective function comprises performing calculations on measurement outputs obtained from the circuit execution. In other words, sub-step S220 comprises performing a similarity-based objective function calculation for data obtained from the measured outputs of the original quantum circuit and the compressed PQC (i.e., the first and second sets of measurement outputs), given the identical random target inputs of step S204. The objective function of sub-step S220 incentivises similar results for different circuits and penalizes the results that differ. The similarity-based objective function implemented at step S220 could be a mean square error function, a Kullback-Leibler divergence function or a cross entropy loss function. The similarity-based objective function could be any alternative, and similar, objective function. The similarity-based objective function is computed after each iteration of steps S206 and S208. One or more results of the similarity-based objective function calculation are used to adjust one or more of the parameters of the compressed PQC.

Optionally, the objective function may use the results of a discriminator network. That is, method 200 may optionally further comprise using a discriminator machine learning model to discriminate between outputs generated by running the first and second versions of the quantum circuit. The discriminator network may be a machine learning model that is trained to classify quantum state measurements and predict the quantum circuit to which the measurements belong. For example, a trained classifier may be used to classify whether a set of measurements has been produced by the original quantum circuit or the compressed PQC. The optional performance of the discriminator network is illustrated by step S224. As a result of sub-step S220, either with or without the optional step S224, a penalty is calculated. The penalty is used as an input to sub-step S222 of step S218.

At sub-step S222, updates for Compressed Quantum Circuit parameters are calculated using the results of the objective function calculation step S220. Sub-step S222 calculates updated versions of compressed circuit parameters to be fed back to the compressed quantum circuit step S208. In other words, the variational parameters of the PQC are adjusted based on the outcome of sub-step S222. This adjustment of variational parameters optimises the objective function of the PQC and maximises the similarity between outputs generated by the quantum circuits of steps S206 and S208. The adjustment of parameters is based on the objective function calculated at step S220. The parameters to be adjusted may be referred to as variational parameters. The parameters to be adjusted (or changed) may be one or more of amplitude, rotation angle, displacement, or any other suitable parameter. Thus, step S222 results in the change of a parameterized approximate quantum circuit by small factor 8g. The change may be calculated via gradient descent or another suitable optimization method.

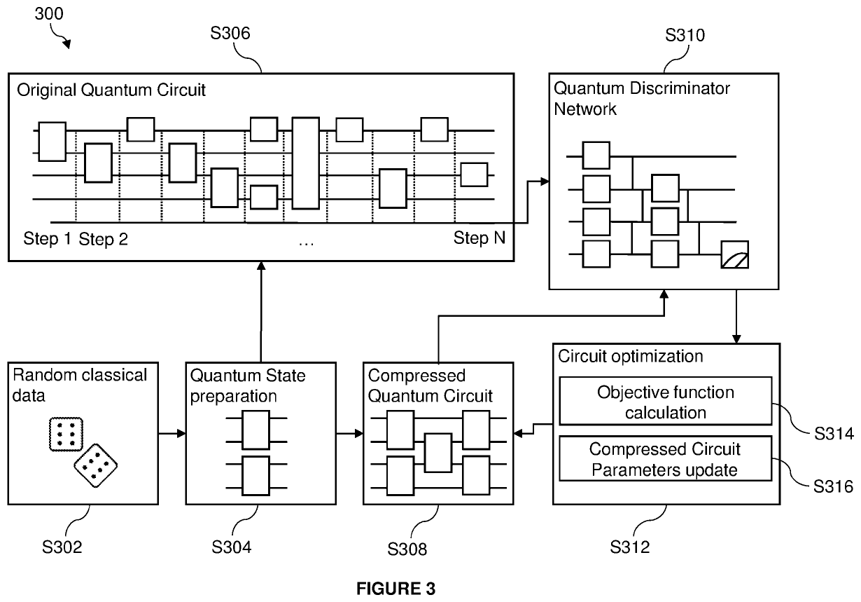

FIG. 3 illustrates a second quantum circuit compression method 300 based on optimization of Quantum Discriminator loss function. The quantum circuit compression method 300 corresponds substantially to that method 200. More specifically, steps S302, S304, S306 and S308 are the same as corresponding method steps S202, S204, S206 and S208 of method 200. That is, as with method 200, method 300 comprises a random classical data step S302, a Quantum state preparation step S304, an original Quantum Circuit generation step S306 and a compressed quantum generation step S308.

However, step S310 differs from step S210 of method 200 in that, instead of performing a quantum state measurement step, method 300 uses a quantum discriminator network to compare the outputs of steps S306 and S308. That is, method 300 does not comprise a quantum state measurement step. Instead, method 300 uses a quantum discriminator network to receive output states of original and approximate quantum circuits and discriminate between two corresponding classes without a need for measurements step. That is, method 300 relies on a comparison of outputs of two quantum circuits which is determined using a quantum discriminator network. The quantum discriminator network is operated at step S310. The quantum discriminator network is a quantum machine learning model (i.e., a quantum circuit that receives a Quantum State as input and classifies it as original or approximate). The quantum discriminator network, or quantum machine learning model, may be comprised of a plurality of quantum neural networks, quantum support vector machines or other quantum classification methods. An advantage of using a quantum machine learning model as an input to circuit optimization step S312 is that this incentivises the compressed PQC to produce a quantum state that maximally resembles state of original quantum circuit.

Circuit optimization step S312 of FIG. 3 uses, as its inputs, the results from the quantum discriminator network step S310 in combination with the results of the compressed quantum circuit that is run at step S308. As with the corresponding step in method 200, the circuit optimization step S312 comprises two sub-steps S314 and S316. Sub-step S314 is an objective function calculation step corresponding to step S220 in method 200. Sub-step S316 is a compressed circuit parameters update step corresponding to step S222 of method 200.

Thus, in sub-step S314 of method 300 the objective function is calculated based on the control qubit measurements of the quantum discriminator which is run at step S310. Then, at step S316 approximate quantum circuit parameter updates are calculated. The parameter updates are used to update the compressed quantum circuit of step S308.

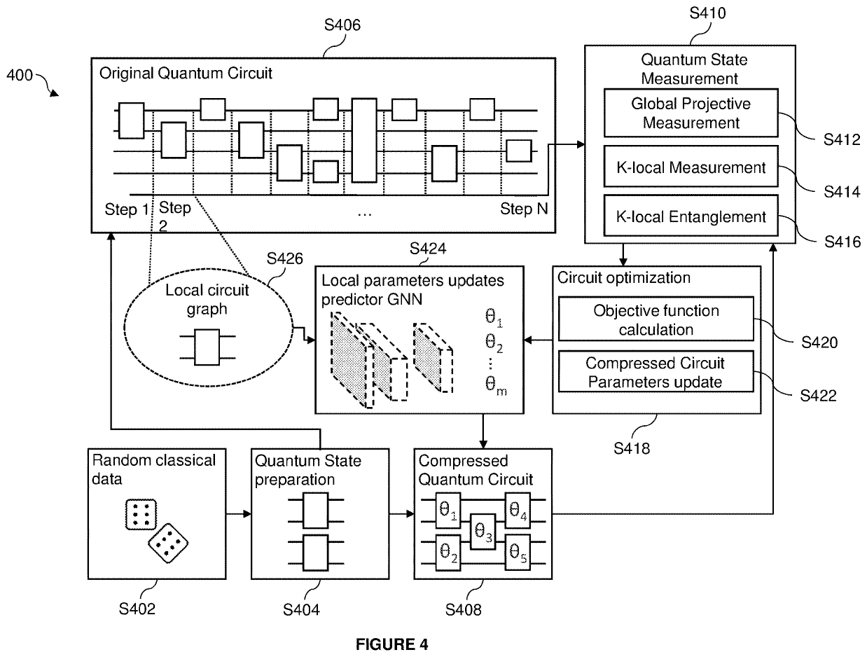

FIG. 4 illustrates a fourth quantum circuit compression method 400 which is based on local update of parameterized quantum circuit. As with method 300, method 400 also corresponds substantially to method 200. More specifically, steps S402, S404, S406 and S408 are the same as corresponding method steps S202, S204, S206 and S208 of method 200. That is, as with method 200, method 400 comprises a random classical data step S402, a quantum state preparation step S404, an original quantum Circuit generation step S406 and a compressed quantum generation step S408.

Method 400 also corresponds to method 200 in that it comprises quantum state measurement step S410 and optimization step S418. Quantum state measurement step S410 is the same as corresponding step S210 of method 200. Quantum state measurement step S410 comprises sub-steps S412, S414 and S416 which are the same as corresponding sub-steps S212, S214 and S216 of method 200. Circuit optimization step S418 also comprises sub-steps S420 and S422, which are the same as corresponding sub-steps S202 and S222 of method 200.

Method 400 differs from method 200 in that it further comprises a step S424 of calculating local parameter update predictions. Step S424 calculates local parameter update predictions using a local predictor model. The local predictor model may be an artificial neural network (ANN) or a graph neural network (GNN). The local predictor model may be based on a local quantum logical operation of a given step of the first version of the quantum circuit. In method 400, the local predictor model is a graph neural network. Thus, in method 400 the update of approximate circuit parameters is predicted by a GNN based on the local graph in the vicinity of locally applied logical gate at execution step n. The local predictor model may comprise layers of a prediction model that receive a local graph circuit S426 from original quantum circuit S406. The local graph circuit may otherwise be described as a slice of the total quantum circuit. The local graph circuit may include the current step gate information for the quantum circuit. After receiving the local circuit graph, the local predictor may predict, based on its training, small updates to approximate (or compressed) PQC such that updated PQC captures action of local quantum operation in the original circuit. That is, the local predictor may predict the necessary parameters for the compressed PQC circuit. In other words, the local predictor may receive an input circuit and output a set of parameters that are used for the PQC.

Method 400 is configured to execute parallel circuit steps S406 and S408 only in the vicinity of locally applied logical gates at execution step n. That is, method 400 comprises adjusting one or more variational parameters of PQC using a local predictor model based on a local quantum logical operation of a given step of the first version of the quantum circuit. The local parameter updates of method 400 are proposed by the local predictor model only to a region of parameters that can be affected by local operation on the PQC. These parameters are located within a corresponding light cone on the original quantum circuit as indicated by step S426.

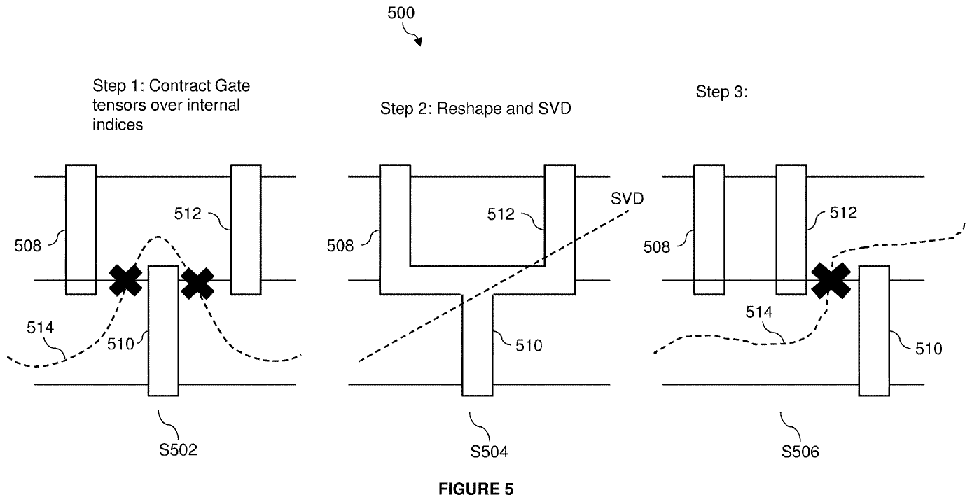

FIG. 5 illustrates a tensor-network-inspired circuit rearrangement process 500 to reduce the number of cuts that are necessary to decompose a quantum circuit into quantum circuit slices. That is, FIG. 5 illustrates a process for simplifying a sequence of gates within a quantum circuit in accordance with the methods disclosed herein. Unlike standard circuit compilation/optimization in which the number of gates is reduced, the process of FIG. 5 optimises the quantum circuit graph in a way that is most optimally cuttable. The process 500 reduces the need of additional circuit cuts by rearranging circuits using a tensor-network decomposition approach. The quantum circuit illustrated in FIG. 5 comprises three quantum logical gates 508, 510, 512. The path through the quantum logical gates is illustrated by reference 514.

The process 500 comprises three steps: step S502, step S504 and step S506. At step S502 (i.e., step 1) the gate tensors are contracted over internal indices. That is, at step S502 the tensors of individual computing operations are contracted over internal indices. Next, at step S504 (i.e., step 2) the gate sensors are reshaped and decomposed. That is, the gate illustrated in step S502 is decomposed into its constituent components at step S504. The gate tensors may be decomposed using singular value deposition. The results of this procedure are illustrated at step S506 (i.e., step 3). That is, step S506 illustrates that gate 512 can be shifted to the left of gate 510 to reduce the complexity of the path 514 through the gates. This can be done without significantly altering the path through the gates.

FIG. 5 illustrates a tensor-network approach. In an alternative example, the steps of FIG. 5 may be performed using a “quantum circuit synthesis” technique. In the quantum circuit synthesis technique, the circuit fragment at step S506 is a PQC that is optimised to reproduce the unitary of a circuit fragment in step S502.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

### Annex

FIG. 1. A system for producing optimised approximate quantum circuit. System operates on 3 or 4 environment. First, user quantum development machine (Linux/Windows with python environment) that runs local SDK to process developed circuit via the cloud backend. Second, classical HPC cluster/server to process circuit from local machine and apply decomposition and compression methods. Third, Quantum Simulator to execute original circuit fragment and their ap-proximate PQC versions. Fourth, Quantum Processing Unit or cluster of QPUs to execute approximate circuits and reconstruct full scale results at classical HPC cluster/server.

FIG. 2. Circuit compression method based on improving similarity of projected measurement results. Covers claim 1, 2, 3. Step 1, random classical vector is prepared and transformed into a quantum state via parametrised quantum circuit (PQC). Step 2 same initial PQC state is plugged as input to Original and Compressed Quantum Circuit (approximation of original) defined also with PQC. Step 3 measurements are performed on both circuits and results are compared using Objective function at Step 4. Alternatively, Discriminator ML model can be used to discriminate between two results and provide penalty to calculate the updates for Compressed Quantum Circuit parameters at Step 5. Figure also depicts step by step strategy for approximation of original circuit, such that original circuit depth grows stepwise.

FIG. 3. Circuit compression method based on optimization of Quantum Discriminator loss function. Covers claim 4. Similarly to strategy in 2 instead of Step 3 of previous approach Step 3 of this method relies on comparison of outputs of two circuits are discriminated using a Quantum Discriminator Network. The objective function in Step 4 is calculated based on the control qubit measurements of Quantum Discriminator. In Step 5 approximate quantum circuit parameters updates are calculated and update is made.

FIG. 4. Circuit compression method based on local update of parametrised quantum circuit. Covers claim 5. Similar to 2 and 3 Step 1 prepares the quantum state and Step 2 executes circuits step by step only in the vicinity of locally applied logical gates at execution step n. The update of approximate circuit parameters is predicted by Graph Neural Network based on the local graph in the vicinity of locally applied logical gate at execution step n.

FIG. 5. Tensor-network-inspired circuit rearrangement strategy to reduce the number of necessary cuts. The procedure allows to reduce the need of additional cuts by rearranging circuits using tensor-network decomposition approach in which tensors of individual operations are contracted and then decomposed using Singular Values Decomposition.

1. A method for reducing the depth of quantum circuits comprising of steps:
a) Random initial quantum state preparation.

To this end:
a1) An array of classical random data is generated from a given distribution: Uniform, Normal, Gaussian, Poisson or other which is based on the specifics of the given quantum algorithm.
a2) The generated vector is used as parameters of a parametrized quantum circuit (PQC)—amplitude, basis, angle, displacement, or similar. The PQC architecture is selected accordingly to input characteristics of the given quantum algorithm. For example, producing state of particular type: no entanglement (quantum product state), low entanglement or high entanglement. Or producing state similar or in the vicinity to given quantum state.
b) Original and approximate Parametrized Quantum Circuits execution with an initial state from step a). Here PQC is used as approximation of original quantum circuit. The form of PQC is chosen based on the properties of original circuit, such as resulting distribution, entanglement and graph properties.
b1) Original and approximate Quantum Circuits are extended with initial state circuit from step a)
b2) Original and approximated Quantum Circuits (algorithms) are executed on classical Quantum Simulator or Quantum Processing Unit-a sequence of defined quantum logical gates is applied to array of qubits.
c) Global, k-local projective measurement and entanglement measurement. A measurement is performed on both Original and Approximated Quantum Circuits by reading out the state of a full qubit array or for a sequence of k qubits. Step results in some binary sequence of 0 and 1 for a qubit array. By repeating the step b) and c) multiple times the statistics of obtaining one or another binary sequence is accumulated. This allows to compute multiple derivative properties of underlying quantum state: entanglement, correlations between qubits, etc.
d) Similarity-based objective function calculation for the measurement outputs of parameterized quantum circuit and input quantum circuit, given identical random initial state from step a). During this step results of the measurement in step c) are compared using objective function that incentifies similar results for different circuits and penalizes results that differ. Based on calculated quantities these could be: Mean Square Error, Kullback Leibler divergence, Cross entropy loss, or similar objective functions.
e) Adjustment of the variational parameters (amplitude, rotation angle, displacement, etc.) of parameterized quantum circuit in order to optimise objective function and maximize similarity between outputs. Based on objective function in step d) the variational parameters (amplitude, rotation angle, displacement, etc.) of parameterized approximate quantum circuits are proposed to be changed by small factor 69, calculated via gradient descent or other optimization methods.
   2. Method of statement 1 further comprised of:
a) Discriminator Machine Learning model (Artificial Neural Networks, regressive methods, support vector machines or other classification methods) to classify if the output is produced by original or approximated parameterized version of the quantum circuit.
   3. Method of statement 1 and statement 2 further comprised of:
a) Step by step increase of the depth of the original quantum circuit after parameters of corresponding parametrized quantum circuit are adjusted optimally for a particular depth. This procedure gradually increases the complexity of state produced by approximate PQC and improves the estimate of factors 69 to adjust the parameters.
   4. Method of statement 1 further comprised of a (see FIG. 3):
a) Quantum Machine Learning model (Quantum Neural Networks, Quantum support vector machines or other quantum classification methods) to receive output states of original and approximate quantum circuits and discriminate between two corresponding classes without a need for measurements step.
b) An objective function based on output of Quantum Machine Learning model. The objective function role is to incentify approximate PQC to produce quantum state that maximally resembles state of original quantum circuit.
   5. Method of graph-based approximate parametrized circuit preparation comprised of steps a) b) c) d) from statement 1 and instead of step e) further comprised of (See FIG. 4):
a) Local predictor model (Artificial Neural Network, Graph Neural Network) based on local quantum logical operation of the given step of original algorithm. This predictor model predicts the small updates to approximate PQC such that updated PQC captures action of local quantum operation in the original circuit. The updates are proposed by predictor model only to region of parameters that can be affected by local operation on the PQC—are located within the corresponding light cone.
   6. A system for producing optimised approximate quantum circuit, comprising of:
a) Circuit compression Software Development Kit (SDK) operating on a end-user classical machine, a laptop, workstation or a cloud machine running a python environment.
b) Classical HPC backend comprised of modules executed sequentially:
b1) Quantum Circuit pre-processing.
b2) Quantum Circuit decomposition into separable fragments requiring smaller number of qubits. This is done either via manual or automatic prescriptions of breaking circuit graph along time (Circuit cutting approach) or logical gate axis (Circuit knitting approach), or similar procedures. The decomposition procedure defines the further rules for reconstruction of results for full quantum circuit.
b3) Quantum Circuit compression using one of the methods from the statement 1 to 5. Compression is performed via corresponding module on HPC backend.
b4) Full circuit result reconstruction module. Module linked to Circuit decomposition module b2) comprising of rules to reconstruct resulting probability distribution produced by a full quantum circuit.
b5) Local Quantum Circuits simulator.
c) HPC Quantum Simulator to execute separable part of decomposed input of Quantum Circuit and corresponding parameterized approximate quantum circuits. HPC Quantum Simulator runs either at on-premise or cloud server (Unix, Linux, Windows) or is provided via API by a third party.
d) Gate-based Quantum Processing Unit to execute parameterized quantum circuits.

1. A method for reducing the depth of a quantum computing algorithm, the method comprising:
generating an array of classical random data values from a selected probability distribution, the array of classical random data values comprising a plurality of vectors;
using one or more of the plurality of vectors as parameters to produce an initial state;
generating an original quantum circuit starting from the initial state; executing the original quantum circuit to obtain a first set of measurement outputs;
generating a compressed parameterized quantum circuit (PQC) starting from the initial state and using the first set of measurement outputs;
executing the compressed PQC to obtain a second set of measurement outputs;
performing a similarity-based objective function calculation on data obtained from the first and second sets of measurement outputs; and
adjusting one or more of the parameters of the compressed PQC based on a result of the similarity-based objective function calculation.

2-24. (canceled)

25. The method of claim 1, further comprising using a discriminator machine learning model to discriminate between outputs generated by running the original quantum circuit and the compressed PQC.

26. The method of claim 25, further comprising increasing the depth of the original quantum circuit on a step-by-step basis.

27. The method of claim 1, wherein obtaining data from the first and second sets of measurement outputs comprises performing quantum state measurements on the original quantum circuit and the compressed PQC by reading out the state of a full qubit array for a sequence of k qubits.

28. The method of claim 27, wherein obtaining data from the first and second sets of measurement outputs further comprises performing one or more of k-local projective measurements and k-local entanglement measurements.

29. The method of claim 1, wherein obtaining data from the first and second sets of measurement outputs comprises using a quantum machine learning model.

30. The method of claim 29, wherein the quantum machine learning model is comprised of a plurality of quantum neural networks or quantum support vector machines.

31. The method of claim 1, wherein adjusting one or more of the parameters of the compressed PQC comprises using a local predictor model based on a local quantum logical operation of a given step of the original quantum circuit.

32. The method of claim 31, wherein the local predictor model is either an artificial neural network or a graph neural network.

33. The method of claim 1, wherein the probability distribution is selected from a group comprising: uniform distribution, normal distribution, gaussian distribution, input probability distribution, and poisson distribution.

34. The method of claim 1, wherein the original quantum circuit is generated using one or more input PQCs, wherein the parameters for the one or more input PQCs comprise one or more of amplitude, basis, angle and displacement, wherein the initial state is selected by the input PQC from one of a no entanglement state, a low entanglement state and a high entanglement state.

35. The method of claim 1, wherein the one or more parameters to be adjusted are selected from a group comprising amplitude, rotation angle and displacement.

36. The method of claim 1, wherein executing the original quantum circuit and the compressed PQC comprises, for each circuit:
extending the circuit from the initial state; and
executing the circuit on a quantum processing unit.

37. The method of claim 1, wherein the similarity-based objective function calculation is selected from a group comprising: a mean square error function, a Kullback-Leibler divergence function, and a cross entropy loss function.

38. A system for reducing the depth of a quantum computing algorithm, the system being configured to:
generate an array of classical random data values from a selected probability distribution, the array of classical random data values comprising a plurality of vectors;
use one or more of the plurality of vectors to produce an initial state;
generate an original quantum circuit starting from the initial state;
execute the original quantum circuit to obtain a first set of measurement outputs;
generate a compressed parameterized quantum circuit (PQC) starting from the initial state and using the first set of measurement outputs;
execute the compressed PQC to obtain a second set of measurement outputs;
perform a similarity-based objective function calculation on data obtained from the first and second sets of measurement outputs; and
adjust one or more of the parameters of the compressed PQC based on a result of the similarity-based objective function calculation.

39. The system of claim 38, further comprising a HPC cluster comprised of the following modules, which are executed sequentially:
a quantum circuit pre-processing module configured to perform pre-processing
operations on received parameterized quantum circuit data;
a quantum circuit decomposition module configured to decompose the quantum circuit into a plurality of quantum circuit slices;
a quantum circuit compression module configured to perform compression of the plurality of quantum circuit slices; and
a results reconstruction module comprising rules for reconstructing resulting probability distribution produced by execution of the parameterized quantum circuit.

40. The system of claim 39, wherein the array of classical random data values is generated by the HPC cluster.

41. The system of claim 39, wherein the HPC cluster further comprises a local quantum circuit execution module.

42. The system of claim 39, wherein the quantum circuit decomposition module is configured to decompose the parameterized quantum circuit into a plurality of quantum circuit slices, wherein the decomposition of the parameterized quantum circuit is performed using a circuit cutting approach or circuit knitting approach.

43. The system of claim 38, wherein the HPC quantum simulator is run either locally, on a cloud server, or via an application programming interface (API) by a third party, wherein the HPC quantum simulator uses an operating platform that is selected from one of Linux (RTM) and Windows (RTM).
